(19) United States
(12) Patent Application Publication
(10) Pub. No.: US 2008/0248147 A1
(43) Pub. Date: Oct. 9, 2008

(54) Apparatus and Method For Producing a Film Having a Tear Guiding Region, and an Extruded Film Having Such a Tear Guided Region

(76) Inventors: Malcom R. Mackley, Cambridge (GB); Bart Hallmark, Grundisburgh (GB); Francis Gadala-Maria, Columbia, SC (US)

Correspondence Address: DORITY & MANNING, P.A., POST OFFICE BOX 1449, GREENVILLE, SC, 29602-1449, US

(21) Appl. No.: 11/659,586

(22) PCT Filed: Aug. 5, 2005
(86) PCT No.: PCT/GB05/03084

§ 371 Date: Feb. 25, 2008

(30) Foreign Application Priority Data
Aug. 7, 2004 (GB) 0417664.0

(51) Int. Cl. B29C 47/14

(52) U.S. Cl. 425/113

(57) ABSTRACT

The invention provides an apparatus (10) for producing a film (2, 70, 170, 270, 370, 470) having a tear guiding region (72, 172, 272, 372, 472). The apparatus includes an extrusion apparatus adapted, in use, to force an extrudable material (8) through a die (14) along an extrusion axis to form an extrudate film. The extrusion apparatus having means for forming a tear guiding region in a film extruded therefrom such that the film comprises at least one primary region (74, 76) and at least one tear guiding region. The means for forming a tear guiding region being adapted such that the tear guiding region has a lower cross sectional area of extrudate than the primary region such that a force applied transverse to the extrusion axis results in a higher stress in the tear guiding region than in the primary region such that a tear in the film will preferentially propagate along the tear guiding region. The invention also provides a method of producing such a film and an extruded film .

The present invention relates to a method and apparatus for producing tear guiding regions in films, particularly the production of tear guiding regions which comprise a microcapillary bore within the film. The invention extends to extruded films having tear guiding regions.

It is well known to form synthetic polymers into lengths of film by passing the polymer, whilst in the soft or molten state, through an orifice in a die. Such a process is known as extrusion moulding and can be applied to a wide range of materials, for example materials which may undergo a physical, chemical or crystallographic change from a fluid or malleable state to a solid state. Thus, the extrusion process can be applied to materials which undergo a chemical reaction to form a solid cured product; to materials which dry either by the evaporation of water or other substances therefrom or by the absorption of water or other substances into a different crystal or morphological form; or to molten or thermoplastic materials which solidify on cooling. The extrusion process is of especial application in the extrusion of thermoplastic polymers such as polyalkylene resins, notably polyethylenes, polypropylenes and alloys or blends thereof. For convenience, the invention will be described hereinafter in terms of the extrusion of a polymer and the term extrudate will be used herein to denote in general all materials which can exist in a viscous, malleable, fluid or semi-fluid form which can be extruded under pressure through the orifice of a die and the term malleable will be used herein to denote the physical state of such a material as it is extruded.

Typically, the material to be extruded is fed as a particulate solid to a cylindrical tube known as the barrel of the extrusion apparatus and is fed along the barrel by a rotating screw drive or auger, a reciprocating ram or other positive transport means. If necessary, the barrel can be heated or cooled to maintain the material within the barrel at an optimum temperature for flow of material through the barrel. The material is forced through an orifice at the end of the barrel, typically an interchangeable die made from a tool steel or other wear resistant material and having an orifice whose cross sectional geometry substantially corresponds to that of the shape which is to be produced. Typically, the cross section of the bore which forms the flow path of the extrudate downstream of the barrel progressively changes until it has the shape of the die orifice. Such change preferably occurs smoothly and the terminal portion of bore may have a cross section which is substantially uniform and corresponds to that of the orifice located at the downstream end of the bore. For convenience, the term die will be used hereinafter to denote that portion of the extrusion equipment through which the extrudate flows downstream of the barrel; the term bore of the die will be used to denote the passage within the die through which the extrudate flows; and the term die exit will be used to denote the orifice through which the extrudate flows from the downstream end of the bore. The die can be formed as a unitary member, with the bore and exit being machined or otherwise formed in a single metal component. Alternatively, the die can be formed in sections so that only the terminal section or sections need be replaced to enable the shape of the die exit and hence of the product to be changed.

Extrusion processes can be used to create films and it is often desirable to be able to accurately tear a film of material along a predetermined path. This applies particularly to packaging when it is desirable to be able to open packaging easily and neatly without spilling the contents of the package due to splitting or inaccurate tearing. Examples of such packaging includes, for example, packaging of seed, snacks and the like. Being able to reliably tear such packaging along a predetermined path allows manufacturers to make more efficient use of the space within the packaging without the fear of a spillage upon opening by a user.

It is also desirable in some circumstances to be able to separate regions of a film product from one another. For example plastic bags may be provided in a roll comprising a plurality of bags attached to one another end-to-end. To separate a single bag from the roll a user must tear along a line between the bag to be separated and the remainder of roll. If the tear is not accurate the bag may be unusable and therefore wasted.

It is also known for a plurality of items to be individually pre-packaged in a strip of film material. It may therefore be desirable to be able to readily separate individual items from the strip prior to use. Items packaged in this way include sterile items such as medical supplies and disposable items. It may also be desirable to be able to accurately separate regions of film from one another along only a portion of the length of the film.

It is known to introduce regions of weakness into extruded films in post-extrusion processes, the regions of weakness being introduced along predetermined paths. The regions of weakness facilitate tearing by causing the tear to preferentially propagate with the region of weakness and therefore along the predetermined path.

Known post-extrusion processes include the creation of perforations through the film along a predetermined path. This creates a region of weakness along said path along which the film will preferentially tear. A region of weakness can also be created by scoring the film using a blade, laser or other device which creates a similar tear guiding region.

It is an object of the invention to provide a more convenient method of creating a tear guiding region in a film.

According to the invention there is provided a method of producing a film having a tear guiding region, the method comprising the steps of using an extrusion apparatus to force an extrudable material through a die along an extrusion axis to form an extrudate film having a length substantially parallel with the extrusion axis, the extrusion apparatus including means for forming a tear guiding region in the film such that the film comprises at least one primary region and at least one tear guiding region, the tear guiding region having a lower cross sectional area of extrudate than the primary region such that a force applied transverse to the first axis results in a higher stress in the tear guiding region than in the primary regions such that a tear in the film will preferentially propagate along the tear guiding region.

By introducing a tear guiding region during the extrusion process the required number of processing operations to create a finished product is reduced and therefore the time and overall cost of the production of a final product is likely to be reduced.

The term extrudate film is used herein to mean an extruded product having length and width dimensions which are substantially perpendicular to one another and a depth dimension substantially perpendicular to both the length and width dimensions. The width and length of the film are typically at least ten times greater than the depth. The reduction in cross sectional area of the film in the tear guiding regions may be from a reduction in the depth of the film, or due to some of the depth of the film being replaced with a fluid (gas or liquid).

The tear guiding region may be formed at any suitable stage during the extrusion operation, but it is preferred that the tear guiding region is formed before post die exit operations are performed on the film. It is therefore preferred that the means for creating the tear guiding region is located within, or forms part of the die so that the tear guiding region is created as the film exits the die. This means that typical post die exit operations, such as drawdown, act on the film including the tear guiding region so that any change in the dimension or shape of the film will correspondingly alter the size and shape of the tear guiding region. Post die exit operations may include drawdown, colouring, cooling or other operations.

The means for forming the tear guiding region may comprise a restriction to the flow of extrudable material at or adjacent the die exit such that the extrudate will preferentially flow around the restriction, thereby forming a region within the flow which has a reduced depth of extrudate in the extrudate film as required.

The restriction to extrudate flow may comprise a narrow portion of the die which produces a region of reduced depth in the film as it is extruded. Preferably the die exit is substantially rectangular having long walls and short walls such that the extrudate film has a substantially rectangular cross section. The narrow portion of the die exit may comprise projections into the flow of extrudable material from one or both of the long walls. The protrusions may be triangular in shape as this produces a suitable shape for reduction in depth of the film and such shapes are comparatively simple to fabricate within a die exit. It should be understood that other shapes could be used for the projections, for example rectangular which would produce an abrupt thickness change.

The restriction to extrudate flow may comprise an obstruction located within the flow of extrudable material and supported upstream such that extrudable material can flow around the obstruction. The result is that the reduction in depth of the film does not comprise a significant indent in only one side of the film, but in both sides of the film. To achieve a similar result with die wall projections, two projections would be required projecting from opposing walls and of substantially equal shape and dimensions.

It is envisaged that such tear guiding regions could have many potential uses. For example, it is proposed that a pair of parallel tear guiding regions within a film could be used to provide a tear off, or tear out, strip in packaging. The tear out strip being used so that that, when removed, access to an interior of the packaging would be possible.

A tear guiding region could be used to provide access to the interior of sealed bags. Bags are typically formed from film material and by providing a top portion of the bag including a tear guiding region so that a tear was guided along a predetermined path. By providing such a guide it would reduce the likelihood of a user splitting the bag, which may result in the spillage of contents. The tear guiding region may be provided in one or both sides of the bag. If the tear guiding region is provided in one side only, it is envisaged that the guided tearing of one side will also guide the tear in the other side. This can apply not only to bags, but any application where it is desirable to tear more than one layer of film at the same time.

Films are often used to cover items such as foodstuffs. It may be desirable to be able to remove a desired length of film from a roll of suitable film stock. Tear guiding regions arranged within the film stock may enable the reliable tearing of the film stock along a predetermined path such that accurate tearing of the film stock can be achieved. Such tear guiding regions may be arranged at intervals along the length of the film stock so that a user can tear the film at a tear guiding region that provides the required length of film.

A plurality of items may be individually sealed within a single strip of film and tear guiding regions may be used to allow a user to separate one or more of the items from the strip as required.

It is preferred that the tear guiding region has a cross section of extrudate at least 20% smaller than the cross section of extrudate in the primary region. Preferably the tear guiding region has a cross section of extrudate of at least 50% and particularly between 70 and 90% smaller than the cross section of extrudate in the primary region.

If a substantially triangular projection is used having one side on a long wall of the die exit and a point projecting into die exit, it is preferred that the width of the projection is of a similar dimension to the height of the projection.

If an obstruction is used to restrict the flow of extrudable material, the obstruction preferably includes a fluid outlet located on a downstream side of the obstruction so that fluid can flow through said outlet and enter the flow of extrudable material. The fluid outlet being connected to a fluid reservoir from which fluid can flow to the outlet to enter the extrudable material flow. Fluid can be injected into the flow of extrudable material under a pressure greater than the pressure within the flow at the outlet, but the fluid outlet is preferably arranged such that extrudable material flows around the obstruction and the reduced pressure on the downstream side of the obstruction caused by the flow of the material draws fluid from the outlet to be entrained with the flow. The fluid drawn from the outlet is preferably entrained within the film to form a fluid filled bore within the film. It is possible that the bore could subsequently be evacuated and sealed. Typically, following drawdown of the extrudate film bores within the film will have diameters in the region of 500 to 50 micrometers in films 1000 to 300 micrometers thick. Fluid from the reservoir entrained within the bore can be a gas or liquid and may serve many different purposes, some of which will be discussed in the following description. It should be understood that the fluid is preferably drawn into the extrudable material flow as described, but may be forced into the flow if required, for example if the fluid to be entrained is viscous. It should be further understood that any such obstruction may be substantially static such that the tear guiding region is substantially parallel with the extrusion axis, but it should be understood that one or more obstructions could move transverse to the extrusion axis, preferably substantially perpendicular to the extrusion axis, so that the position of the tear guiding region within the film can be adjusted and the tear guiding region need not form a substantially straight line.

Entraining fluid within the flow of extrudable material enables the fluid to replace at least some of the extrudable material in the cross section through the extrudate film without providing any significant increase in the tear resistance of the film. The depth of the film may remain substantially unchanged in the tear guiding region and this means that disruption to the outer surfaces of the film for a given reduction in cross sectional area of extrudate is greatly reduced and, in some cases, substantially eliminated, whilst the tear guiding property of the region is maintained.

This means that an improved surface finish to the film can be achieved whilst still providing the desired tear guiding region.

An obstruction including a fluid outlet can be positioned within the die upstream of the die exit, at or adjacent to the die exit or downstream of the die exit. The exact position of the outlet within the flow of extrudable material will depend upon the geometry of the die exit, the size and shape of the obstruction, the speed of the flow of extrudable material and the desired properties of the film and tear guiding region. A suitable size and position of outlet for a given desired result can be readily determined through trial and error.

The obstruction is preferably needle shaped with a long axis of the needle being aligned with the extrusion axis and the downstream end of the needle including a fluid outlet connected with a fluid reservoir. A needle shaped obstruction provides a low resistance to the flow of extrudable material within the die and does not disrupt the flow of material particularly thereby facilitating the formation of a stable bore of entrained fluid.

A plurality of such needles can be included within the die such that an extrudate film can be created which includes a plurality of tear guiding regions so that primary regions of the film can be separated from one another.

Any fluid outlet within the flow may include means by which it can be selectively coupled to, or de-coupled from, the fluid reservoir during extrusion so that the bores within the film can be initiated and terminated as desired. In this way an internally ‘perforated’ tear guiding region can be created without perforations passing completely through the film. This may be useful for films which may be used in providing air tight coverings, whilst retaining a similar look and feel to conventional perforations.

It has been mentioned above that many different fluids can be introduced into the film during extrusion. Although any fluid can be used, the following fluids are considered to provide particularly advantageous results.

A scent or perfume could be inserted within the tear guiding region so that when the film is torn the scent is released. This may be particularly useful for packaging in which a scent is released as the package is opened, perfume samples or the like as only a small sample of scent is required to fill the bore. The bore can also be made air tight by sealing at each end to avoid evaporation of the scent.

A dye could be included to create a tamper resistant seal on, for example, food packaging or valuable consignments. If the seal was broken, the dye would be spilled and it would be obvious that the seal had been tampered with.

If a plurality of needles are included within the die exit, they may be of different shapes, or have different outlet bore sizes so that the resulting bores can have different uses. It is envisaged that in a film including a plurality of capillary bores some of which may be used as flow path for fluids with others being used as tear guiding regions so that the flow paths can be separated by tearing along the tear guiding regions. This would enable a central length of the film to remain intact to help ensure that the fluid paths remained neat and one did not get kinked or damaged. Flow paths in end regions of the film could be separated so that the separated flow paths could be connected to respective sources of fluid and to the targets for fluid delivery.

It is also envisaged that the films may be foamy films which may be used to pack delicate objects and may need to be readily torn to different lengths.

It should be understood that a the plurality of bores created from a plurality of needles may all have the same dimensions, but some could be used as tear guides, while others are used as fluid paths.

The invention will now be further described, by way of example, with reference to the accompanying drawings, in which:

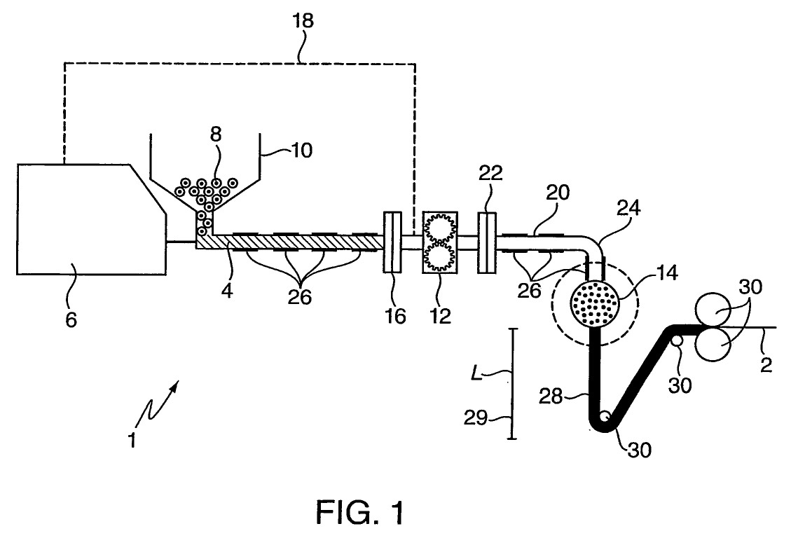

FIG. 1 shows an extrusion apparatus suitable for use in the present invention;

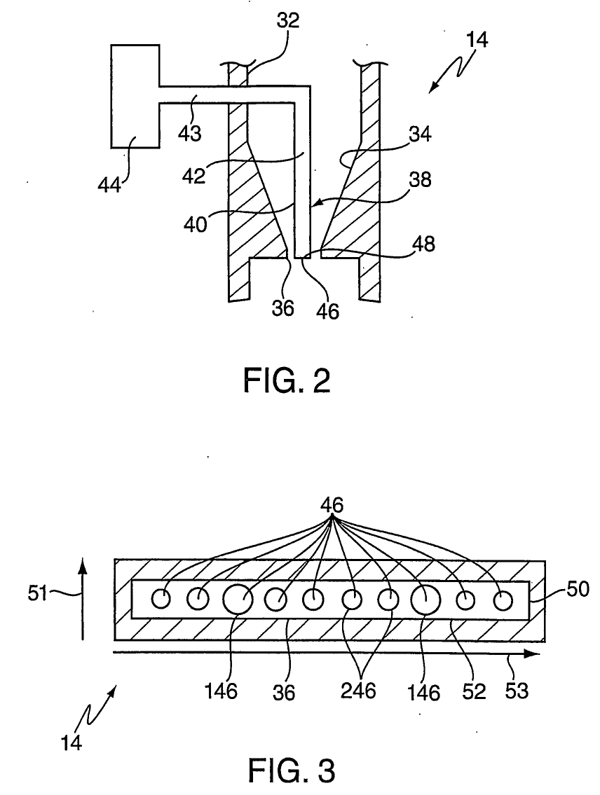

FIG. 2 shows a die exit having a needle shaped obstruction which includes a fluid outlet at an end;

FIG. 3 shows a die exit including a plurality of needle shaped obstructions including fluid outlets;

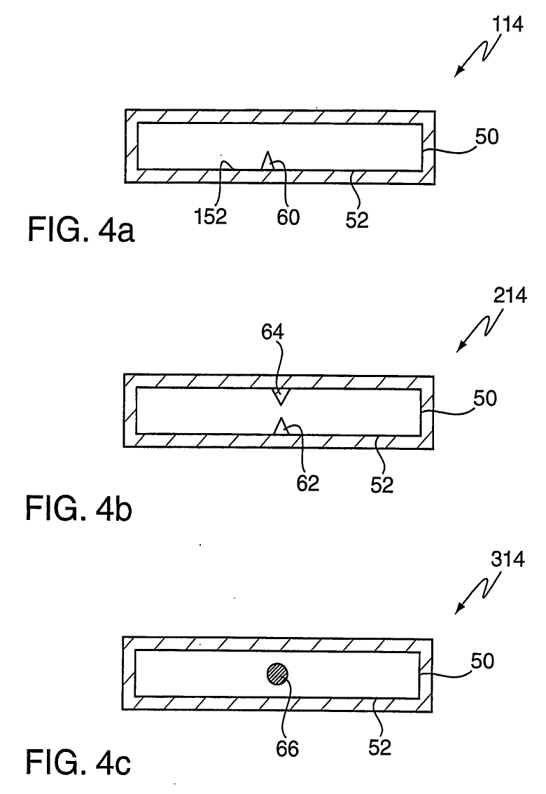

FIGS. 4a, 4b and 4c show shapes of die exits;

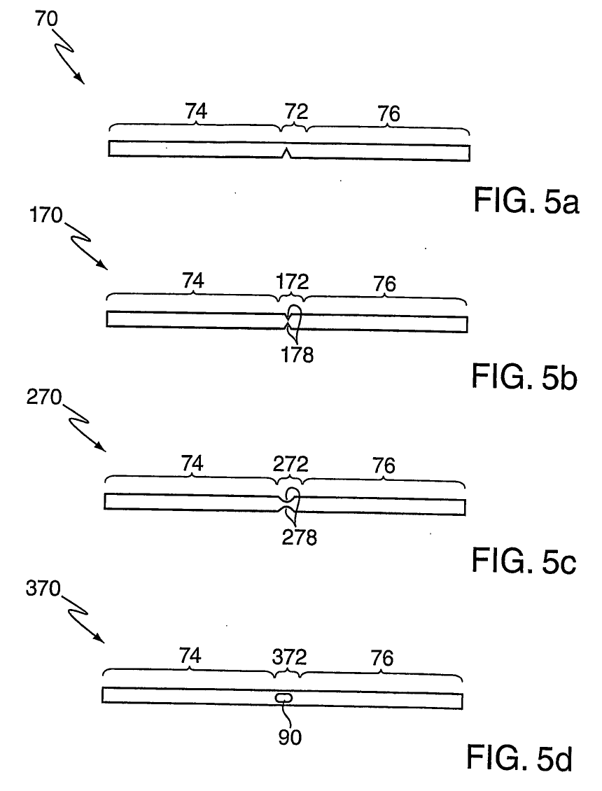

FIGS. 5a, 5b and 5c show cross sections through films including tear guiding regions; and

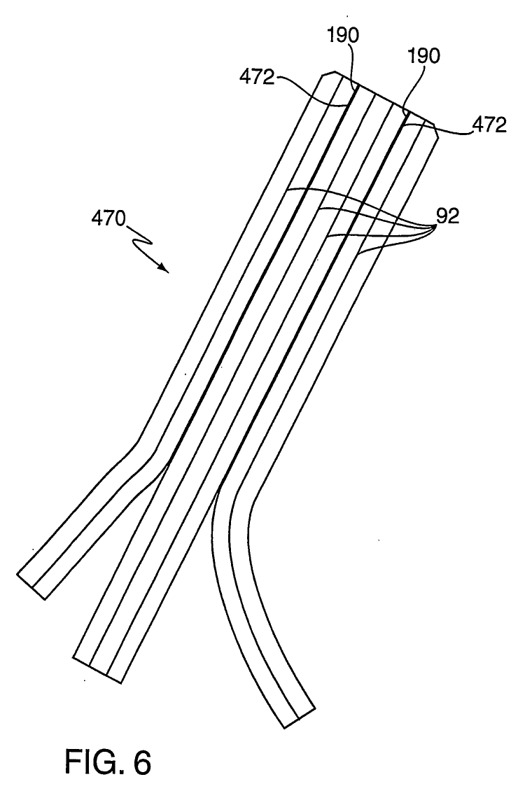

FIG. 6 shows a film including a plurality of bores and a plurality of tear guiding regions.

FIG. 1 shows extrusion apparatus 1 for creating an extrudate film product 2 having tear guiding regions. The extrusion apparatus comprises screw extruder 4 driven by a motor 6. Extrudable material 8 is fed to the extruder screw 4 through a hopper 10. As the extrudable material passes through the extruder screw 4 the material is melted to form a melt (not shown). The extruder screw 4 feeds the melt to a gear pump 12 which maintains a substantially constant flow of melt towards a die 14. The gear pump 12 is connected to the extruder screw 4 by a flange 16 which includes a screen filter to remove impurities from the melt flow. The motor 6 is controlled using a pressure feedback loop 18 between the inlet of the gear pump and the motor 6.

The melt passes to the die 14 through an extruder barrel 20 which is connected to the gear pump by a flange 22. In this embodiment the extruder barrel includes a 90° bend 24. Band heaters 26 are used to control the temperature at different stages in the extrusion apparatus 1. Band heaters 26 may be located within the extruder, on the flanges 16,22, on the gear pump 12, on the extruder barrel 20 and also on the die 14.

The detail of the arrangement of the die 14 will be shown in greater detail in subsequent figures.

The melt passes through the die 14 and is formed into the desired shape and cross section. As the melt passes out of the die exit it becomes an extrudate 28. The extrudate 28 is drawn down over and between rollers 30. The drawing down process alters the cross section of the extrudate 28 to form the extrudate product 2. A draw length (L) 29 is defined between the orifice and the first roller 30. It has been found that L has a great effect on the extrudate product 2 formed by this apparatus.

FIG. 2 shows a schematic cross section through the die 14 of FIG. 1. The die includes an entry portion 32, a convergent portion 34 and a die exit 36 which has a predetermined outer shape. The melt enters the entry portion 32 of the die 14, is gradually shaped by the convergent portion 34 until the melt exits the exit 36.

The die 14 further includes needles 38 (only one of which is shown in this figure) positioned therein. The needle 38 a body portion 40 having a conduit 42 therein which is fluidly connected to a fluid source 44 by means of a second conduit 43 passing through a wall of the die 14 around which the melt must flow to pass to the orifice 36. The needle 38 further includes an outlet 46 at an end 48 of the needle 38. The needle 38 is arranged such that the outlet 46 is located within the die exit 36.

FIG. 3 shows a schematic view of a die 14 from below. This diagram shows that the orifice 36 has a substantially rectangular outer shape. The orifice has a short side 50 substantially parallel with a short axis 51 and a long side 52 substantially parallel with a long axis 53.

In this example, the die includes ten needles 38 with the outlets 46 distributed substantially evenly along the long axis 53 within the orifice and substantially centrally in the orifice along the short axis 51. In this example, the die orifice has a short side dimension of 1.5 mm and a long side dimension of 18 mm. The outlets 46 of the needles have differing dimensions. Larger outlets 146 are adapted to produce tear guiding regions, whilst smaller outlets 246 are adapted to produce fluid conduits.

FIGS. 4a, 4b and 4c show shapes of die exits that may be used in the die of FIG. 1.

FIG. 4a shows a substantially rectangular die exit 114 having long walls 52 and short walls 50. One of the long walls 152 includes a triangular projection 60 that extends into the die exit 114 to form a flow restriction. As extrudable material is forced through the die exit 114 the extrudable material is forced to flow around the projection. 60. The resulting extrudate film will include a region in which the depth, and hence the cross section, of extrudate is reduced due to the restriction to the flow. The region of reduced cross section will act as a tear guiding region if the dimensions of the resulting reduction in cross section are sufficient for a tear to preferentially propagate within that region.

FIG. 4b shows a die 214 similar to the die 114 shown in FIG. 4a, but the die 214 of FIG. 4b includes opposing triangular projections 62,64 from both long walls 52. These projections 62,64 act in the same way as the projection 60 in FIG. 4a, but there will be a depression in both sides of the resulting extrudate film product to create the reduction in cross sectional area of extrudate.

FIG. 4c shows a die 314 similar to the die 114 in FIG. 4a, except that the die 314 of FIG. 4c includes an obstruction 66 within the die exit 314 rather than a projection 60 from an edge 152 of the die. The obstruction 66 is substantially circular in cross section, but could be of any shape, and is located substantially centrally within the die exit, but could be located in other positions. The obstruction 66 is supported upstream of the die exit in a similar way to the needle 38 shown in FIG. 2. The obstruction 66 creates a restriction to the flow of extrudable material and will therefore create a reduction in the cross section of the resulting extruded film product.

It should be understood that other shapes of obstruction or projection could be used and that combinations of one or more projections and/or one or more obstructions could also be used, the obstructions may or may not include fluid outlets.

FIG. 5a shows a cross section through an extruded film product 70. The cross section is substantially perpendicular to the length of the film. The film 70 includes a tear guiding region 72 and two primary regions 74,76. The tear guiding region 72 has a lower cross sectional area of extrudate along a line parallel with the length of the film 70 than the primary regions 74,76. The reduction in cross sectional area is as a result of an indentation 78 in a lower surface 80 of the film 70. The indentation 78 reduces the thickness of extrudate within the tear guiding region 72. Such a film 70 could be produced using a die 114 such as that shown in FIG. 4a.

FIG. 5b shows an extruded film product 170 having two primary regions 74,76 and a tear guiding region 172 which includes indentations 178 in an upper and lower surface of the film 170. Such a film 170 could be produced using a die 214 such as that shown in FIG. 4b.

FIG. 5c shows an extruded film product 270 having two primary regions 74,76 and a tear guiding region 272 which includes indentations 278 in an upper and lower surface of the film 270. The indentations 278 are not as well defined as in FIG. 6b. Such a film 270 could be produced using a die 214 such as that shown in FIG. 4c.

FIG. 5d shows an extruded film product 370 having two primary regions 74,76 and a tear guiding region 372 which includes a capillary bore 90 therein. Such a film 370 could be produced using a die 214 such as that shown in FIG. 4c, but with the obstruction 66 including a fluid outlet such that a fluid, for example air, could be entrained within the flow.

FIG. 6 shows an extruded film 470 which includes tear guiding regions 472 comprising capillary bores 190 and fluid conduits 92. The film 470 has been partially torn along the tear guiding regions 472 to separate some of the fluid conduits 92 from others.

Description of an Exemplary Process

A polymer melt is produced in a screw extruder 4 and its resultant flow rate stabilised by means of a gear pump 12. This melt is then fed into a die 14 in the orifice of which is arranged an outlet from a needle 38. A conduit 42 through the needle 38 is fed from a horizontally orientated feed conduit 43, the entrance of which is open to the atmosphere outside of the die which is the fluid source 44. The resulting extrudate is then passed over a series of rollers 30 into a haul-off device (not shown). The speed of the haul-off device can be altered so that extrudate products 2 with differing draw ratios can be produced.

The die 14 is designed such that the incoming flow from the extruder, which is contained in a circular pipe, is altered such that it may pass through the orifice 36 of the die 14. The die 14 must effect this geometry change, and this is currently achieved by using a convergent die 14.

The die 14 is also designed so that the flow over the needle 38 is substantially even. An even melt flow around the needle 38 facilitates creation of well-formed extrudate 28. If, however, there is an uneven flow, the melt will preferentially channel along a path of least resistance. This results in a distorted extrudate 28, which can also result in inconsistent draw down distortions.

The process is operated at about 165° C. using linear low-density polyethylene (LLDPE). The motor 6 is controlled using a pressure feedback loop 18 that is set to 300 psi (20.7 bar) and this, in turn, causes a pressure of around a few bar in the die 14. Air is entrained as a result of the polymer flow over the needles 3 and the feed to this needle 38 is left open to the atmosphere. The velocity of the polymer melt at the die orifice 36 is of the order of a centimetre a second, the velocity of the haul off device can be set anywhere between zero and 9 metres a minute.

A parameter that was found to have substantial influence on the final product was the distance L 29, shown in FIG. 1 and defined to be the distance between the die exit and the first roller 30. In fact, in this case the first roller is a stationary polished stainless steel rod submerged in a water bath.

Tear Mechanism

It has been noted that when tearing the film by pulling apart the two sides by hand at the rate at which one normally tears a piece of paper the film splits into two parts along the capillary and the edges of the two parts are fairly straight. However, when the two sides of the film are pulled apart at rates of 10 mm/s or less, the edges of the two parts into which the film is split are curvy and have a wavy edge. It has been found that the force required to tear the film is different depending on the mode of tearing. A Texture Analyser manufactured by Stable Micro Systems was used to measure the force required to tear films. The force required to tear a film quickly was measured by clamping one end of the film to the Texture Analyser and pulling the other end by hand. The force required to tear the film slowly was measured by clamping both ends to the Texture analyzer and pulling them apart at a rate of 10 mm/s.

The force required to tear quickly a film having a single capillary bore was fairly constant and close to 2 newtons. The force required to tear such a typical film slowly varied between about 1 and 9 newtons. When the film was torn slowly, it was observed that a web of stretched film formed in the region where the two sides of the film were being pulled apart. As the web grew the force required to tear the film increased. Eventually, the web would break and the force would drop abruptly to its low value from which it would again increase as a new web formed.

In some cases, as the film was torn slowly, the tear propagated away from the tear guiding region and the film split to one side. To ensure that the tear propagates along the tear guiding capillary it is important that the reduction in the cross section in the tear guiding region is appropriate for the anticipated tear speed and force.

It is proposed that this difference in the tearing mechanisms occurs due to the changes in the stress/strain curves for materials dependent upon the speed of the application of the strain.

It is also noted that, in some cases it is difficult to initiate the tearing by hand and some sort of initiation was required. This usually involved forming a slit along the tear guiding region from which to initiate a tear.

Ideally, in order to have good tearing characteristics, there should be a rapid transition between a narrow region of extrudate in the tear guiding region and a wider region of extrudate in the primary region so that the stress concentration causes the narrow region to reach the fracture point of the extrudate material before the primary region of the material begins to plastically deform.

In the stress/strain curve for most materials there is a stress barrier that must be overcome before plastic deformation occurs. Ideally the shape of the tear guiding region is such that, at the anticipated tear speed, the fracture point of the material is reached within the tear guiding region before the stress in an adjacent wider region, such as a primary region, increases above the stress barrier for plastic deformation. The shape of the transition, the difference in cross sectional area of extrudate and the tear speed all have an effect on the mode of tearing.

Role of the Microcapillary

To test the role of the microcapillary in aiding the tear guiding, three films were extruded under similar conditions, those films are referred to as MCF4, MCF5 and MCF6. MCF4 was extruded with a single microcapillary in the centre of the film produced by allowing air to be entrained through a hollow needle placed about 1 mm upstream of the exit of the die. MCF5 was extruded under the same conditions as MCF4, except that the needle was blocked and acted as an obstruction. Since the injector needle was in the same position, MCF5 exhibited a similar narrow region in the middle of the film, but because the needle was blocked, it had no microcapillary. MCF6 was extruded using the same extrusion parameters as MCF4 and MCF5 except that in this case the injector needle was placed about 4 mm upstream of the exit of the die. Even though the injector needle was open, MCF6 had no capillary because placing the injector far upstream does not produce the drop in pressure required to entrain the air. Also, because the needle does not obstruct the flow of polymer as much when it is that far upstream, MCF6 had a cross section that is more uniform along the film. These three films were about 375 micrometers thick.

Upon tear testing, both MCF4 and MCF5 tore in a straight line when torn quickly, and tore with a wavy edge when torn slowly. MCF6 never tore along the middle of the film. It always tore to one side, even though the tear was initiated by a long cut with a sharp blade along the middle of the film.

When torn quickly, MCF4 required a fairly constant force of about 3.5 newtons, whereas MCF5 required a fairly constant force of about 5.0 newtons. Therefore, although a straight tear can be obtained with a microcapillary or with a narrow region in the film, the force required to tear the film is smaller when the microcapillary is present.

When torn slowly, the force to tear MCF4 varied widely as a web of stretched polymer between the sides of the film being pulled apart intermittently grew and broke. For MCF4 the tearing force varied mostly between about 3 and 9 newtons. The force required to tear MCF5 slowly was more uniform than that for MCF 4 varying only between about 7 and 9 newtons.

Examination of the torn cross sections makes it clear that when the films are torn quickly the walls of the microcapillary of MCF4 (and the narrow region of MCF5) stretch and break leaving the rest of the film relatively unaffected. However, when the films are torn slowly, the adjacent regions of the film have also been stretched. The fact that a larger region of film is being stretched explains the larger force required to tear the film, and the additional surface area created by the stretching of the sides of the film explains the resulting wavy edges.

The data gathered indicates that when torn quickly, the thin walls of the microcapillary (or the narrow region in the film without a microcapillary) break before they have time to affect the adjacent regions. However, when pulled slowly, the stretched microcapillary walls (or stretched narrow region) do not break before first stretching the adjacent regions of the film.

Characteristics of a Film that Tears Well

Based on these observations it is proposed that in order to tear the film in a straight line with a minimum amount of force, the walls of the microcapillary should be thin and adjacent to wide areas of the film. A narrow region close to the microcapillary runs the risk of being stretched before the walls of the microcapillary break requiring a larger tearing force and resulting in a wavy edge.

It should be understood that the invention has been described above by way of example only and that modifications in detail may be made without departing from the scope of the invention.

1. Apparatus for producing a film having a tear guiding region, the apparatus comprising an extrusion apparatus adapted, in use, to force an extrudable material through a die along an extrusion axis to form an extrudate film having a length substantially parallel with the extrusion axis, the extrusion apparatus including means for forming a tear guiding region in a film as it is extruded therefrom such that the film comprises at least one primary region and at least one tear guiding region, the means for forming a tear guiding being adapted such that the tear guiding region has a lower cross sectional area of extrudate than the primary region such that a force applied transverse to the first axis results in a higher stress in the tear guiding region than in the primary regions such that a tear in the film will preferentially propagate along the tear guiding region.

2-20. (canceled)
